(19) United States
(12) Patent Application Publication
(10) Pub. No.: US 2008/0178647 A1
(43) Pub. Date: Jul. 31, 2008

(54) Rotary Cylinder Lock Which Can Be Actuated with a Multi-Groove Key

(75) Inventor: Herve Calor, Creeteil Cedex (FR)

Correspondence Address: OSHA LIANG L.L.P., 1221 MCKINNEY STREET, SUITE 2800, HOUSTON, TX, 77010, US

(73) Assignee: Valeo Securite Habitacle, Creteil (FR)

(21) Appl. No.: 11/884,161

(22) PCT Filed: Feb. 2, 2006
(86) PCT No.: PCT/EP06/50626

§ 371 Date: Aug. 10, 2007

(30) Foreign Application Priority Data
Feb. 11, 2005 (FR) 05001447

(51) Int. Cl. E05B 29/00; E05B 65/12

(52) U.S. Cl. 70/237; 70/492

(57) ABSTRACT

The invention relates to a rotary cylinder lock (1) which is designed to be actuated with a multi-groove key. The inventive lock comprises: a rotor (10) which is mounted such that it can rotate inside a stator (20) and at least one spring which is mounted such that it can move inside a guide housing (41, 42, 43, 44, 45, 46) between a locked position and an unlocked position each spring being coupled to an elastic return means which moves same into the locked position. The invention is characterised in that each guide housing (41, 42, 43, 44, 45, 46) can receive two different types of springs which can co-operate respectively with each of the two key grooves which extend such as to oppose the drive force exerted by the associated elastic return means when the key is inserted into the rotor.

The present invention relates to a rotary cylinder lock which is intended to be operated using a key that has a plurality of distinct grooves.

The invention finds particularly advantageous, although not exclusive, application in the field of motor vehicle lock mechanisms.

A rotary cylinder lock is, schematically speaking, made up of a plug mounted so that it can move in axial rotation within a casing, and of locking means able to prevent the rotation in question. The assembly is designed in such a way that activation and/or deactivation of the locking means, and the turning of the plug, are done using a key.

Among the known devices in the prior art, it is possible to single out those the plug of which can be prevented from turning by a plurality of wafers which are mounted to slide transversely in guide housings formed through said plug.

The mobility of each wafer is generally between a locked position in which one end of the wafer in question is at least partially inset in an immobilizing housing formed in the casing, and an unlocked position in which said wafer is substantially fully integrated into the plug.

In order to be certain to prevent the plug from being turned when the key corresponding to the lock is not inserted, each wafer is commonly coupled to an elastic return means which constantly drives it towards the locked position.

The assembly is also arranged in such a way that inserting the key into the plug axially is able to cause each wafer to slide from its locked position into its unlocked position.

Of course, the resistance of a rotary cylinder lock to picking is directly connected to the degree of sophistication of the key associated with it. In this instance, this resistance is dependent on the number of grooves formed along the insert of the key in question and which are actually used when decoding the wafers.

The movement of each wafer between its locked position and its unlocked position is actually conventionally caused by the sliding of a bearing surface of said wafer along one of the grooves of the key when the latter is inserted into the plug. It will hence be understood that using a maximum number of grooves makes it possible to make the uncoding of the wafers more complicated and therefore make the task of anyone wishing to force such a lock more difficult.

At the present time, a four-groove key, that is to say a key that has four distinct active bittings is a solution that offers one of the best compromises in terms of structural simplicity and high level of security. Figuratively speaking, in such a configuration, the wafers are split into two groups which are installed top to toe within the plug, and the associated elastic return means are arranged in such a way as to cause each group of wafers to move in directions which are parallel but in the opposite sense. It should be noted that the wafers within one and the same group, that is to say those which are driven in one and the same sense of the direction, are then able to collaborate with the two grooves of the key, which are formed respectively on the two faces, in opposition with respect to the direction in which said wafers are driven.

This type of rotary cylinder lock with four-groove key does, however, present the disadvantage of allowing only a relatively fixed distribution of the wafers within the plug, in that the various wafers that can be installed in one and the same guide housing will always collaborate with the same groove of the key; only the heightwise position of the bearing surface varies from one wafer to another according to the groove profile adopted for each key.

Now, the fact that the wafers always come into contact with the key at the same points, and that this is true irrespective of the distribution adopted, means that it is easier to read the code. This is because anyone with ill intentions and in possession of a key will be able, using the signs of wear, to determine the logical succession in which the wafers have been installed and by additionally assessing the various possible bearing surface heights on the basis of various groove profiles, he will then, with relative ease, be able to deduce all the conceivable combinations.

Hence, the technical problem that is to be solved by the subject matter of the present invention is that of proposing a rotary cylinder lock intended to be operated by a key with multiple grooves, said lock comprising a plug mounted so that it can move in axial rotation within a casing, and at least one wafer mounted such that it can move in a guide housing formed through the plug, between a locked position in which it prevents the axial rotation of said plug and an unlocked position in which it allows said axial rotation, each wafer being, on the one hand, coupled to an elastic return means which constantly urges it into the locked position and, on the other hand, able to be moved into the unlocked position by sliding along one of the grooves of the key when said key is fully inserted into the plug, which lock would make it possible to avoid the problems of the prior art by offering, in particular, substantially improved resistance to picking without in any way jeopardizing the structure of the plug and of the casing, for obvious cost reasons.

The solution to the technical problem set consists, according to the present invention, in the fact that each guide housing is equally able to receive two distinct types of wafer which are respectively able to co-operate with each of the two grooves of the key and are intended to extend in opposition to the driving force exerted by the associated elastic return means when said key is inserted into the plug.

It should first of all be emphasized that the invention applies perfectly well to any kind of multiple-groove key, independently of the number and relative position of the grooves actually used, and irrespective of the orientation of each set of notches, that is to say whether it's internal or external.

It should then be noted that the mobility of each wafer may be any, provided that it moves between a locked position that prevents the axial rotation of the plug and an unlocked position that allows said axial rotation.

It must incidentally be pointed out that the driving force may be of any origin, particularly may be a thrusting force or a pulling force depending on the precise nature of the elastic return means used.

Whatever the case, the invention as thus defined has the advantage that the distribution of the wafers can truly be changed within one and the same plug when this plug needs to be adapted to suit a new key. The principle is, from one key to another, to change the points of contact of the various wafers with the grooves of the key in question. In this respect, this principle can be likened to that of the rotary codes encountered in the field of computing.

It is therefore not merely a case of substituting one wafer for another, these differing only in the difference in the height at which the bearing surface lies, but truly in replacing it with another type of wafer which is able to collaborate with the groove formed substantially at the same level on the other face of the key insert.

The fact that each guide housing can be equipped, as desired, with two distinct types of wafer makes it possible to increase the number of possible combinations, for the same number of guide housings. This feature thus makes it possible to make reading the key and therefore decoding the wafers, far more difficult. More generally though, it quite obviously also improves the resistance of the lock to conventional forcing techniques of the lock-picking type to be considerably improved.

The present invention also relates to the features which will become evident in the course of the description which will follow, and which are to be considered in isolation or in any technically feasible combination.

This description, which is given by way of nonlimiting example, is intended to provide a better understanding of what the invention consists of and how it may be embodied. It is also given with reference to the attached drawings in which:

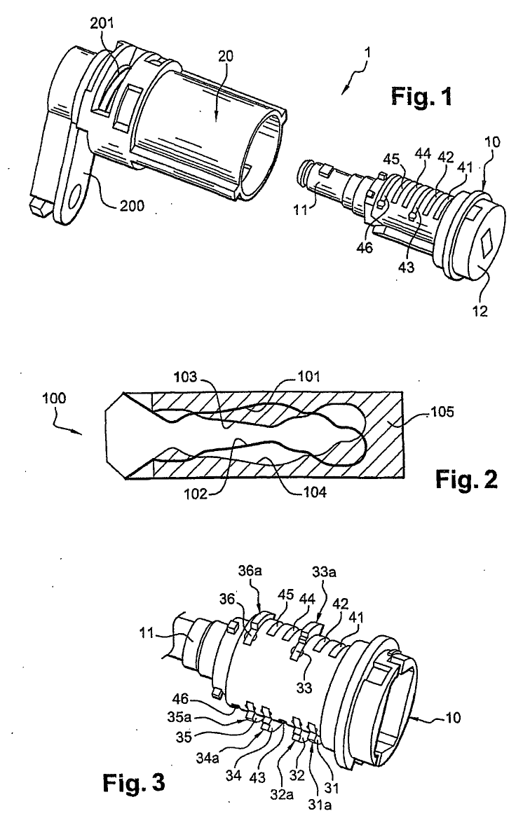

FIG. 1 is an exploded view illustrating a rotary cylinder lock according to the invention.

FIG. 2 is a side view of the insert of a key compatible with the lock of FIG. 1; the four grooves of said key being represented simultaneously as hidden detail.

FIG. 3 shows the plug in perspective from the front, with the wafers in the locked position.

FIG. 4 is a view similar to FIG. 3, but in perspective from the rear.

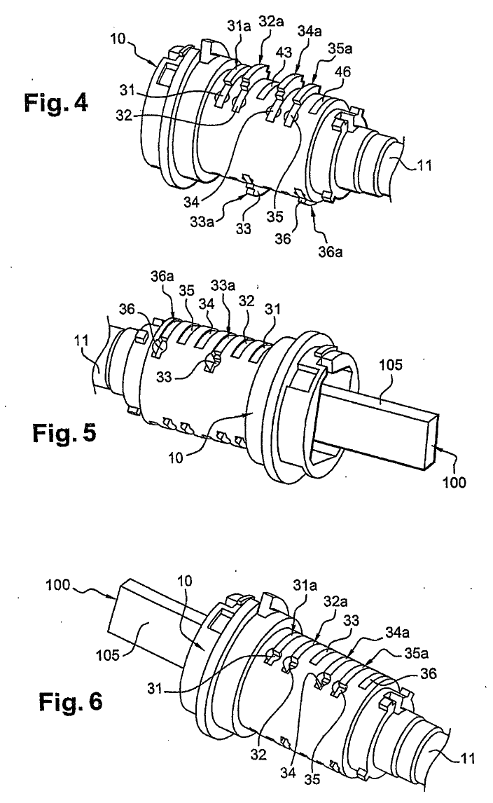

FIG. 5 is a perspective view from the front of the plug in which the key insert is inserted; the wafers being in the unlocked position.

FIG. 6 is a view similar to FIG. 5, but in perspective from the rear.

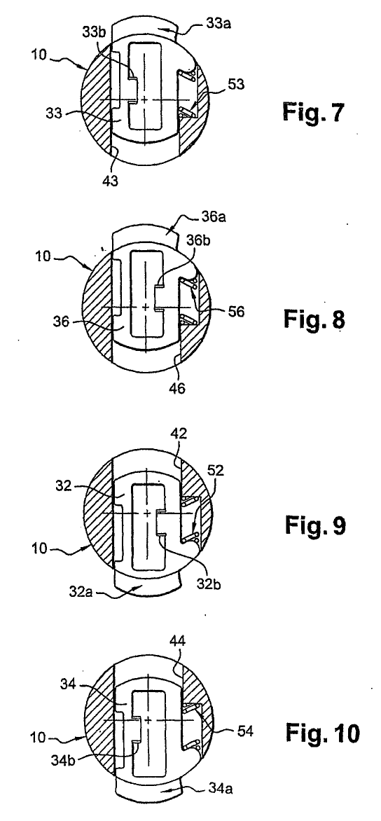

FIG. 7 constitutes a cross section through the plug, the section being taken in line with a first wafer.

FIG. 8 is a cross section through the plug, the section being taken in line with a second wafer.

FIG. 9 is a cross section through the plug, the section being taken in line with a third wafer.

FIG. 10 is a cross section through the plug, the section being taken level with a fourth wafer.

For the purposes of clarity, the same elements have been denoted by identical references. Likewise, only those elements that are essential for understanding the invention have been depicted, and these have been thus represented schematically, and not to scale.

FIG. 1 illustrates a rotary cylinder lock 1 intended to be fitted to a device for locking/unlocking an opening panel of a motor vehicle and which is designed to be operated using a key 100 provided with an insert 105 that has four grooves 101, 102, 103, 104, partially visible in FIG. 2.

It can be clearly seen from this FIG. 1 that the lock 1 is mainly made up of a plug 10 mounted such that it can move in axial rotation inside a casing 20. By contrast, it cannot be seen that the lock 1 comprises a number of wafers 31, 32, 33, 34, 35, 36, the purpose of which is to prevent the plug 10 from being turned with respect to the casing 20 when the key 100 is not inserted in the plug 10. The wafers in question 31, 32, 33, 34, 35, 36 have actually not been depicted in this first figure in order to emphasize the presence of the guide housings 41, 42, 43, 44, 45, 46 formed through the plug 10.

The plug 10 constitutes the moving part of the lock 1. It therefore supports the wafers 31, 32, 33, 34, 35, 36 and collaborates by inserting with the insert 105 of the key 100 and has a cover 12. By contrast, the casing 20 forms the fixed part of the lock 1. It acts both as a guiding support and as an immobilizing means for the plug 10 and is designed in this instance to be fixed rigidly to the opening panel of the motor vehicle.

FIG. 1 also shows the presence of a lever 200, the purpose of which is mechanically to enable or disable the lock mechanism to which the lock 1 is coupled. In order to be able to be pivoted when the plug 10 is axially rotated by the key 100, the lever 200 is able to be secured rigidly to the end 11 of said plug 10. A return spring of the spiral type 201 is conventionally provided.

In this particular embodiment, selected solely by way of example, the plug 10 is able to be prevented from turning by six wafers 31, 32, 33, 34, 35, 36 mounted to slide transversely in six guide housings 41, 42, 43, 44, 45, 46 formed through said plug 10. The mobility of each wafer 31, 32, 33, 34, 35, 36 is between a locked position (FIGS. 3 and 4) in which one of its ends 31a, 32a, 33a, 34a, 35a, 36a projects from the surface of the plug 10 and is partially inset in an immobilizing housing formed inside the casing 20, and an unlocked position (FIGS. 5 and 6) in which said wafer 31, 32, 33, 34, 35, 36 is substantially fully integrated into the plug 10.

In accordance with that which is depicted in FIGS. 7 to 10, each wafer 31, 32, 33, 34, 35, 36 is coupled to an elastic return means 51, 52, 53, 54, 55, 56 which constantly urges it into its locked position. The objective is to guarantee that the plug 10 is prevented from rotating with respect to the casing 20 when the key 100 is not inserted in the lock 1. It should also be noted that even though these have not been illustrated directly, the elastic return means 51 and 55 which are associated with the guide housings 41 and 45 and with the wafers 31 and 35 have the same structural and functional features as their counterparts depicted here.

In this currently preferred embodiment of the invention, each elastic return means 51, 52, 53, 54, 55, 56 consists of a cylindrical compression spring which constantly exerts on its associated wafer 31, 32, 33, 34, 35, 36 a longitudinal thrust force towards the locked position.

Each wafer 31, 32, 33, 34, 35, 36 is made to slide between its locked position (FIGS. 3 and 4) and its unlocked position (FIGS. 5 and 6) in a way that is entirely conventional here. This movement is in fact caused by the sliding of a bearing surface 31b, 32b, 33b, 34b, 35b, 36b formed on the wafer 31, 32, 33, 34, 35, 36 along one of the grooves 101, 102, 103, 104 of the key 100, as the insert 105 effects a translational movement inside the plug 10. The assembly is arranged in such a way that fully inserting the insert 105 means that each wafer 31, 32, 33, 34, 35, 36 can be driven precisely into the unlocked position.

As in any lock 1 that can be operated using a key 100 with four grooves 101, 102, 103, 104, the wafers 31, 32, 33, 34, 35, 36 are split into two groups which are installed top to toe within the plug 10. The elastic return means 51, 52, 53, 54, 55, 56 associated with them are also arranged in such a way as to cause each group of wafers 31, 32, 34, 35; 33, 36 to move in directions that are parallel but in opposite sense. It should be noted that the wafers 31, 32, 34, 35; 33, 36 of any one same group, that is to say those which are driven in the same sense of the direction, are then able to collaborate with the two grooves 101, 102, 103, 104 formed respectively on the two faces of the key 100, in opposition with respect to the direction in which said wafers 31, 32, 34, 35; 33, 36 are driven.

According to the subject matter of the present invention, each guide housing 41, 42, 43, 44, 45, 46 is equally able to accept two distinct types of wafer 31, 32, 33, 34, 35, 36 which are respectively able to collaborate with each of the two grooves 101, 103; 102, 104 of the key 100 which are intended to stretch in opposition with respect to the driving force exerted by the associated elastic return means 51, 52, 53, 54, 55, 56 when said key 100 is inserted into the plug 10.

As can be seen in FIGS. 7 to 10, the wafers 33 and 36 form part of the same group, because they are made to slide in the same direction, in this instance upwards. However, within this group, the wafers 33 and 36 belong to two different types of wafer given that they are intended to collaborate respectively with the grooves 103 and 101 of the key 100.

The wafers 32 and 34 for their part form part of another groove because they are slid in another common direction, namely downwards. Further, within this second group, the wafers 32 and 34 belong to two different types of wafer, given that they are designed to collaborate respectively with the grooves 102 and 104 of the key 100.

If this logic were to be followed, the last two wafers 31 and 35 would have to be classified into the second group because they are also driven downwards, independently of the position of their respective bearing surfaces.

By way of a concrete example and according to the subject matter of the present invention, the wafer 33 in the guide housing 43 (FIG. 7) could be replaced by a wafer similar to the wafer 36 in the guide housing 46 (FIG. 8), and vice versa. Likewise, the wafer 32 in the guide housing 42 (FIG. 9) could be swapped with a wafer similar to the wafer 34 in the guide housing 44 (FIG. 10), and vice versa.

According to a particularly advantageous feature of the invention, the lock 1 is provided with at least four wafers 32, 33, 34, 36 which are able to collaborate respectively with each of the four grooves 101, 102, 103, 104 of the key 100.

This specificness makes it possible to guarantee that all the grooves 101, 102, 103, 104 of the key 100 are actually active, that is to say that they are all used to effect when decoding the wafers 31, 32, 33, 34, 35, 36. The lock 1 may then be considered to be a true four-groove lock.

According to another particular feature of the invention, all the elastic return means 51, 52, 53, 54, 55, 56 are installed in the plug 10 on the same side of the wafers 31, 32, 33, 34, 35, 36.

This feature is of manifest benefit in terms of the manufacturing method because grouping all the springs together on the same side means that they can be crimped in simultaneously, thus ultimately simplifying the assembly of the lock 1.

Although this specific feature has not been employed in the exemplary embodiment chosen to illustrate the invention, the lock 1 may also advantageously comprise substantially as many wafers 33, 36 driven into their locked position in a given direction as it does wafers 31, 32, 34, 35 driven into the locked position in the opposite direction.

It should be noted that the phrasing “substantially as many” means “as many” when there is an even number of wafers, and means “the same number give or take one” if there is an odd number thereof.

This feature means that, whatever the situation, it is possible to guarantee a certain uniformity in the distribution of the wafers 31, 32, 33, 34, 35, 36 positioned in top to tail positions, thus optimizing the number of possible combinations.

Of course, the invention relates to any locking/unlocking device provided with a rotary cylinder lock 1 as described hereinabove. It should be emphasized that a locking/unlocking device means any mechanism essentially comprising a locking mechanism controlled by a lock. The invention is particularly aimed at a locking/unlocking device for any opening panel of a motor vehicle.

Moreover, the invention relates more generally to any motor vehicle provided with at least one locking/unlocking device as defined hereinabove.

1. A rotary cylinder lock intended to be operated by a key with multiple grooves, said lock M comprising a plug mounted so that it can move in axial rotation within a casing, and at least one wafer mounted such that it can move in a guide housing formed through the plug, between a locked position in which it prevents the axial rotation of said plug and an unlocked position in which it allows said axial rotation, each wafer being, on the one hand, coupled to an elastic return means which constantly urges it into the locked position and, on the other hand, able to be moved into the unlocked position by sliding along one of the grooves of the key when said key is fully inserted into the plug, wherein each guide housing is equally able to receive two distinct types of wafer which are respectively able to co-operate with each of the two grooves of the key and are intended to extend in opposition to the driving force exerted by the associated elastic return means when said key is inserted into the plug.

2. The lock as claimed in claim 1, wherein it comprises at least four wafers respectively able to collaborate with each of the four grooves of the key.

3. The lock as claimed in claim 1, wherein it comprises substantially as many wafers that are driven into the locked position in a given direction as it does wafers driven into the locked position in the opposite direction.

4. The lock as claimed in claim 1, wherein all the elastic return means are installed in the plug on the same side of the wafers.

5. The lock as claimed in claim 1, wherein each wafer is mounted to slide inside its guide housing between the locked position and the unlocked position.

6. The lock as claimed in claim 1, wherein each elastic return means consists of a cylindrical compression spring which constantly exerts on its associated wafer, a longitudinal thrust towards the locked position.

7. The lock as claimed in claim 1, wherein, in the locked position, each wafer has a portion which is at least partially inset into an immobilizing housing formed in the casing.

8. The lock as claimed in claim 1, wherein, in the unlocked position, each wafer is substantially completely integrated into the plug.

9. A locking/unlocking device, particularly for a motor vehicle, wherein it comprises a rotary cylinder lock.

10. A motor vehicle, wherein it comprises at least one locking/unlocking device as claimed in claim 9.

11. The lock as claimed in claim 2, wherein it comprises substantially as many wafers that are driven into the locked position in a given direction as it does wafers driven into the locked position in the opposite direction.

12. The lock as claimed in claim 2, wherein all the elastic return means are installed in the plug on the same side of the wafers.

13. The lock as claimed in claim 3, wherein all the elastic return means are installed in the plug on the same side of the wafers.

14. The lock as claimed in claim 2, wherein each wafer is mounted to slide inside its guide housing between the locked position and the unlocked position.

15. The lock as claimed in claim 3, wherein each wafer is mounted to slide inside its guide housing between the locked position and the unlocked position.

16. The lock as claimed in claim 4, wherein each wafer is mounted to slide inside its guide housing between the locked position and the unlocked position.

17. The lock as claimed in claim 2, wherein each elastic return means consists of a cylindrical compression spring which constantly exerts on its associated wafer, a longitudinal thrust towards the locked position.

18. The lock as claimed in claim 3, wherein each elastic return means consists of a cylindrical compression spring which constantly exerts on its associated wafer, a longitudinal thrust towards the locked position.

19. The lock as claimed in claim 4, wherein each elastic return means consists of a cylindrical compression spring which constantly exerts on its associated wafer, a longitudinal thrust towards the locked position.

20. The lock as claimed in claim 5, wherein each elastic return means consists of a cylindrical compression spring which constantly exerts on its associated wafer, a longitudinal thrust towards the locked position.
